(19) United States
(12) Patent Application Publication
(10) Pub. No.: US 2025/0382160 A1
(43) Pub. Date: Dec. 18, 2025

(54) Work apparatus

(71) Applicant: ROTZLER HOLDING GMBH + CO. KG, Steinen (DE)

(72) Inventor: Ferdinand Römer, Schönenberg (DE)

(73) Assignee: ROTZLER HOLDING GMBH + CO. KG, Steinen (DE)

(21) Appl. No.: 19/236,234

(22) Filed: Jun. 12, 2025

(30) Foreign Application Priority Data
Jun. 14, 2024 (EP) 24182273.3

(51) Int. Cl. B66C 13/40; B66C 15/00

(52) U.S. Cl. CPC B66C 13/40; B66C 15/00

(57) ABSTRACT

A work apparatus includes an actuator system with an actuator and a control unit. To control the actuator system, the control unit issues an instruction for the actuator system. The control unit includes an instruction unit and a safety unit. The instruction unit creates a provisional instruction for the actuator system. A set of impermissible instructions is defined in the safety unit. The safety unit checks whether the provisional instruction is in the set of impermissible instructions and only permits the forwarding of the provisional instruction to the actuator system in unmodified form if the provisional instruction is outside the set of impermissible instructions and/or checks whether the provisional instruction is in the set of permissible instructions and only permits the forwarding of the provisional instruction to the actuator system in unmodified form if the provisional instruction is within the set of permissible instructions.

### CROSS-REFERENCE TO RELATED APPLICATION

This application claims the benefit of European Patent Application EP 24182273.3, filed on Jun. 14, 2024, the content of which is incorporated in its entirety.

### BACKGROUND

In work apparatuses comprising an actuator system with at least one actuator and a control unit for controlling the actuator system, it is customary for the control unit to issue an instruction for the actuator system in order to control the control unit. It must be ensured that this instruction does not lead to operating states that endanger or damage the work apparatus, the operator of the work apparatus or the environment of the work apparatus. Particularly in the case of upgrades or adjustments to the control unit, for example in form of changes to the software of the control unit, it must be reliably ensured that such operating states do not occur. This poses a problem in particular if the work apparatus is supplied to an end user and the latter is meant to be able to adjust the control unit themselves, for example by changing the software, to meet specific requirements. However, even if the control unit, in particular the software of the control unit, is being upgraded in the factory, it cannot be ruled out that the upgrade may result in impermissible operating states of the work apparatus.

### SUMMARY

The disclosure is based on the object of developing a work apparatus of the type mentioned above in such a way that the work apparatus can be flexibly adjusted and upgraded and at the same time the safety of the work apparatus is ensured.

This object is solved by a work apparatus as claimed.

The work apparatuses comprises an actuator system with at least one actuator and a control unit for controlling the actuator system. The control unit comprises an instruction unit and a safety unit. The safety unit is functionally arranged between the instruction unit and the actuator system. The instruction unit creates a provisional instruction for the actuator system. A set of impermissible instructions and/or of permissible instructions is defined in the safety unit. The safety unit checks whether the provisional instruction is in the set of impermissible instructions. Alternatively or additionally, the safety unit checks whether the provisional instruction is in the set of permissible instructions. The safety unit only permits forwarding of the provisional instruction to the actuator system in unmodified form if the provisional instruction is outside the set of impermissible instructions. Alternatively or additionally, the safety unit only permits forwarding of the provisional instruction to the actuator system in unmodified form if the provisional instruction is within the set of permissible instructions. This makes it possible to modify the control unit by accessing the instruction unit, in particular the software of the instruction unit. The safety unit simultaneously ensures that after modifying the control unit, in particular by modifying the instruction unit, in particular by modifying the software of the instruction unit, no instruction that is an impermissible instruction is sent to the actuator system. This allows the control unit, in particular the instruction unit, to be flexibly adapted to the needs of an end user, even by the end user themselves. The control unit, in particular the instruction unit, in particular the software of the instruction unit, can also be upgraded in the factory without a problem. Errors which might arise during such an upgrade and lead to impermissible instructions for the actuator system are detected by the safety unit during operation of the work apparatus after the instruction unit has created a provisional instruction. Forwarding of an impermissible instruction to the actuator system can then be avoided. The work apparatus can also prevent the forwarding of all other impermissible instructions to the actuator system. In particular, the operator of the instruction unit can suggest the creation of a specific instruction and such a suggestion is then checked by the safety unit and rejected if necessary. This further enhances the flexibility of the work apparatus. It can be easily and safely adapted to the needs of the operator and/or the working environment.

An impermissible instruction carried out by the actuator system leads to an operating state or action of the actuator system that impairs or endangers the safety of the operator, the work apparatus or the environment, in particular in the meaning of the ISO 13849 Standard.

In particular, the safety unit prevents a provisional instruction from being forwarded to the actuator system if it is in the set of impermissible instructions. Alternatively or additionally, the safety unit prevents a provisional instruction from being forwarded to the actuator system if it is outside the set of permissible instructions. Expediently, the control unit then issues either no instruction at all or a modified instruction, in which case the modified instruction is then outside the set of impermissible instructions or within the set of permissible instructions.

In an advantageous development, it is provided that the control unit, in particular the instruction unit, is designed to be coupled to at least one operating device. The operator can specify by means of the at least one operating device which provisional instruction the instruction unit creates. Owing to the safety unit, no requirements are placed on the design of the operating device, in particular in terms of safety. The same type of operating device can be used for a wide variety of work apparatuses. The work apparatus then ensures that the provisional instructions specified by the operating device, in particular in terms of operating safety, are permissible. The work apparatus, in particular the control unit, in particular the instruction unit, can be upgraded completely independently of the operating device. Even after the work apparatus, in particular the control unit, in particular the instruction unit, has been upgraded or changed, the same operating device can be used. The operating device does not need to be adapted. This reduces the production costs. Because the operating device can be used without taking account of safety aspects in the software or in a user interface of the operating device, the operating device can be manufactured easily and inexpensively.

Advantageously, the control unit, in particular the safety unit, transfers a user interface, in particular a menu structure, to the at least one operating device when the at least one operating device is coupled to the control unit. This enables a very flexible use of the at least one operating device for different work apparatuses. When the operating device is coupled to the respective work apparatus, the operating device then receives in each case the user interface, in particular the menu structure from the work apparatus itself. This means that the operating device can be used flexibly and can easily be manufactured. It is not necessary to adapt the operating device to the respective work apparatus. This same operating device can be used for different work apparatuses.

In particular, a plurality of operating devices can be coupled to the control unit. Advantageously, the operator can specify by means of the plurality of operating devices which provisional instructions the instruction unit creates. Due to the plurality of operating devices, complex provisional instructions can be created by the instruction unit in this way. In particular, such a complex provisional instruction can relate to a plurality of actuators of the actuator system. The control unit, in particular the safety unit, checks whether the operation of the plurality of actuators at the same time corresponds to a permissible instruction.

It can be provided that each operating device of the plurality of operating devices is assigned a sub-instruction. In particular, the sub-instruction can be transmitted from the respective operating device to the instruction unit. Advantageously, the instruction unit creates the provisional instruction from the individual sub-instructions which originate from the various operating devices. If the thus created provisional instruction is within the set of impermissible instructions or (alternatively or additionally) outside the set of permissible instructions, the safety unit modifies the provisional instruction in particular as if the chronologically last sub-instruction had not been taken into account for the creation of the provisional instruction. Expediently, the work apparatus is designed in such a way that this process of modifying the provisional instruction as if the chronologically last sub-instruction had not been taken into account for the creation of the provisional instruction is repeated until the modified provisional instruction is outside the set of impermissible instructions or (alternatively or additionally) within the set of permissible instructions. Advantageously, the safety unit then permits forwarding of the modified instruction to the actuator system. In particular, by taking the chronologically last sub-instruction into account for the creation of the modified provisional instruction, it is possible, for example, to avoid unnecessarily interrupting the operation of the work apparatus. The provisional instruction is then composed of the sub-instructions that chronologically precede the last sub-instruction or corresponds to the chronologically first sub-instruction.

By way of example, the sub-instruction can relate to merely one of a plurality of actuators. If another actuator is to be put in operation by a subsequent sub-instruction and this would result in an impermissible operating state, this is avoided by the described process. Nevertheless, uninterrupted further operation of the actuator that was put in operation first is possible. In particular, the sub-instructions can be conveyed from the respective operating devices to the instruction unit at different points in time. Expediently, on arrival of a new sub-instruction, a new provisional instruction is always created by the instruction unit created. This provisional instruction is then advantageously checked by the safety unit.

In particular, the actuator system comprises a plurality of actuators. Advantageously the control unit issues the instruction for the plurality of actuators. In particular, such an actuator system comprising the plurality of actuators may be sent impermissible instructions. The safety unit ensures that these impermissible instructions do not reach the actuator system. As a result, the work apparatus is safe and can nevertheless be flexibly adapted to the respective use conditions.

Expediently, the instruction unit, the safety unit and/or the actuator system are connected to one another for the transmission of data, in particular for the transmission of the instruction, by means of a field bus, in particular by means of a CAN (controller area network) bus. This makes secure and reliable communication between the aforementioned components possible.

Advantageously, the safety unit is designed in such a way that it assigns an instruction that does not meet the ISO 13849 Standard to the set of impermissible instructions. In particular, the safety unit assigns an instruction that meets the ISO 13849 Standard to the set of permissible instructions. Alternatively or additionally, the safety unit is designed in such a way that it assigns an instruction that meets the ISO 13849 Standard to the set of permissible instructions.

In one particular configuration, the actuator system comprises a winch, a motor for pivoting a jib arm of a crane, a hydraulic cylinder and/or a motor for driving a wheel for locomotion, in particular of the work apparatus. An impermissible instruction may then be, for example, simultaneous operation of the motor for pivoting the jib arm of the crane and of the motor for driving the wheel for locomotion. Operating the winch and the motor for pivoting the jib arm of the crane simultaneously might also be considered an impermissible instruction.

In particular, the work apparatus is a crane. A control unit comprising an instruction unit and a safety unit is particularly advantageous for a crane. During operation of a crane, numerous impermissible instructions and/or operating states may arise.

In an advantageous refinement, the work apparatus is an integral part of an arrangement which comprises at least one operating device in addition to the work apparatus. Expediently, a first data channel for the transmission of digital data is formed between the control unit and the at least one operating device. Advantageously, the first data channel is a fieldbus, in particular a CAN (controller area network) bus.

The CAN bus is in particular a serial bus system. The CAN bus enables the exchange of information. In technical terms, the controller area network is described by a data connection layer and a physical layer. The physical layer of the CAN bus defines components such as cable types and their impedance, electrical signal level and node requirements. For a high-speed CAN network, the ISO 11898-1 Standard describes the data connection layer. The Standard 11898-2 describes the physical layer. In particular, the CAN nodes are connected via a two-wire bus with a data transmission rate of up to 1 Mbit/s, in particular of up to 5 Mbit/s. In particular, the CAN bus is properly terminated, in particular with a 120 Ohm CAN bus termination resistor at each end of the bus. The CAN bus enables the different components of the arrangement, in particular the control unit and the at least one operating device, and in particular the actuator system, to communicate with each other without complex special wiring. In particular, functionally secure communication between the control unit and the at least one operating device is possible over the first data channel.

Advantageously, a second data channel for the transmission of digital data is formed between the control unit and the at least one operating device. The second data channel is used in particular to transmit data at a higher data transmission rate than is possible with the first data channel. In particular, data that is not safety-relevant can be transmitted over the second data channel. In particular, real-time communication between the at least one operating device and the control unit over the first data channel is possible. Because there is both a first data channel for the transmission of safety-relevant data and a second data channel for the transmission of non-safety-relevant data, secure and fast communication is possible at the same time.

In an advantageous refinement, it is provided that the arrangement is designed in such a way that data can be transmitted over the second data channel by means of the black channel principle.

The black channel principle is used in safety-related systems in which communication components that do not meet the requirements for secure data transmission are used. In this case, in particular, a safety protocol is integrated between the safety application and the insecure standard communication channel, which corresponds to the safety level of the safety-related system and detects and controls transmission errors in the underlying communication layers. That is to say, the integrity of the non-secure transmission channel is continually monitored by a higher level secure protocol.

In particular, at least one section of the second data channel is termed a black channel. In particular, Ethernet is used as communication method for the second data channel. Expediently, at least one section of the second data channel is formed by an Ethernet cable. In particular, the Ethernet cable forms a black channel.

By applying the black channel principle, safety-relevant data can also be transmitted over the second data channel, in particular data for creating a safety-relevant instruction in the control unit, in particular a safety-relevant instruction. Safety-relevant data is, in particular, data which is associated with a motion-triggering instruction or an instruction that causes an emergency shutdown. A motion-triggering instruction causes the work apparatus or a component of the work apparatus to move.

In particular, the second data channel comprises a first transceiver point on sides of the at least one operating device. Expediently, the second data channel comprises a second transceiver point on sides of the control unit. Expediently, both the first and the second transceiver point are formed by a fieldbus, in particular a CAN (controller area network) bus. As a result, a safety protocol which detects and controls transmission errors in the underlying communication layers is integrated in the second data channel. The safety protocol is in particular a safety-related fieldbus protocol that meets the IEC 61158 (basic communication), IEC 61784-2 (real-time communication) and/or IEC 61784-3-18 (safety profile) Standard. Due to this design of the second data channel, a section of the second data channel can use Ethernet as communication method. This makes fast and secure data transmission possible at the same time. Secure information can be transmitted via the same Ethernet network that is also used to transmit broadband-intensive information. With such a design of the second data channel, the first data channel can also be dispensed with.

In an advantageous refinement, the at least one operating device can be supplied with power via the second data channel, in particular via the Ethernet cable. This makes it easy to supply the operating device with power.

It can also be provided that at least one section of the second data channel is formed by a wireless connection, in particular by a WLAN (wireless local area network) connection or a Bluetooth connection. This makes it easy to transmit information broadband-intensively.

An exemplary embodiment of the invention will be explained hereinafter with reference to the drawing.

### BRIEF DESCRIPTION OF THE DRAWINGS

FIG. 1 shows a schematic illustration of an arrangement comprising a work apparatus and at least one operating device.

### DETAILED DESCRIPTION

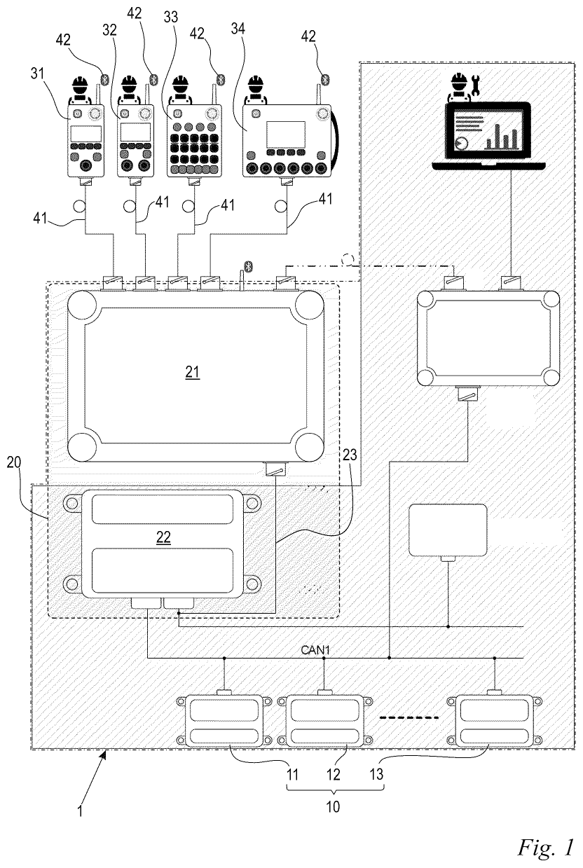

FIG. 1 shows a work apparatus 1. The work apparatus 1 is part of an arrangement comprising the work apparatus 1 and at least one operating device 31, 32, 33, 34. The work apparatus 1 is an electrical work apparatus. The arrangement in the exemplary embodiment is a mobile arrangement. In particular, the arrangement is able to travel. In particular, the work apparatus has at least one mobile component. In the exemplary embodiment, the arrangement is a crane. However, the arrangement may also be a winch or a vehicle with a winch.

In the exemplary embodiment, the work apparatus 1 comprises all of the component parts of the crane apart from the at least one operating device 31, 32, 33, 34 and the corresponding connection for transmitting data between the at least one operating device 31, 32, 33, 34 and the work apparatus 1.

The work apparatus 1 comprises an actuator system 10. The actuator system 10 comprises at least one actuator 11, 12, 13. In the exemplary embodiment according to FIG. 1, the actuator system 10 comprises the first actuator 11, the second actuator 12 and the third actuator 13. The actuator system 10 can comprise a winch, a motor for pivoting a jib arm of the crane, a hydraulic cylinder and/or a motor for driving a wheel for locomotion, in particular for driving a wheel for locomotion of the crane, in particular for driving a wheel for locomotion of the vehicle. In the exemplary embodiment, the first actuator 11 is a winch. In the exemplary embodiment, the second actuator 12 is a motor for pivoting a jib arm of the crane. The jib arm is a mobile component of the work apparatus 1. In the exemplary embodiment, the third actuator 13 is a wheel for locomotion of the crane. The crane is mobile. The crane is able to travel.

The work apparatus 1 comprises a control unit 20. The control unit 20 is used to control the actuator system 10. In particular, the control unit 20 is used to control the first actuator 11, in particular to control the second actuator 12 and/or in particular to control the third actuator 13. The work apparatus 1 is designed in such a way that, to control the actuator system 10, the control unit 20 issues an instruction for the actuator system 10. To electronically convey the instruction, the work apparatus 1 has an instruction channel CAN1. The instruction channel CAN1 is used to convey data. In the exemplary embodiment, the instruction channel CAN1 is a fieldbus, in particular a CAN (controller area network) bus. The instruction channel CAN1 fulfils the criteria mentioned in the introduction to the description in connection with the CAN bus.

Issuing an instruction for the actuator system 10 by the control unit 20 corresponds to conveying a control signal 20 from the control unit 20 to the actuator system 10. In the exemplary embodiment, the control signal is an electrical signal. Issuing the instruction for the actuator system 10 causes the actuator system 10, in particular the at least one actuator 11, 12, 13, to be put in an operating state corresponding to the instruction. The work apparatus 1 is designed in such a way that the instruction issued by the control unit 20 is implemented by the actuator system 10, in particular by the at least one actuator 11, 12, 13.

The instruction may be, for example, that a motor of the first actuator 11 designed as a winch is to be switched on or switched off. Analogously, an instruction for the actuator system 10 can specify that the second actuator designed as a motor for pivoting the jib arm of the crane is to be switched on or switched off. Analogously, the control unit 20 issuing the instruction for the actuator system 10 can have the effect that the third actuator designed as a motor for a wheel is switched on or off. In particular, the instruction is a control signal that is sent from the control unit 20 to the actuator system 20. In particular, the instruction affects the actuator system 10 in such a way that the actuator system 10 is put in an operating state in accordance with the instruction.

The control unit 20 comprises an instruction unit 21 and a safety unit 22. The safety unit 22 is functionally arranged between the instruction unit 21 and the actuator system 10. The instruction unit 21 is used to create a provisional instruction for the actuator system 10. A set of impermissible instructions is defined in the safety unit 22. The set of impermissible instructions can be stipulated by certain basic conditions. By way of example, it can be stored in the safety unit 22 that the at least one actuator 11, 12, 13 of the actuator system 10 may only be operated within certain limit values. However, it can also be stored that one of the plurality of actuators 11, 12, 13 may not be operated at the same time as another one of the plurality of actuators 11, 12, 13. It can also be provided that, as an alternative or in addition to defining the set of impermissible instructions in the safety unit 22, a set of permissible instructions is defined in the safety unit 22.

The control unit 20 is designed in such a way that the safety unit 22 checks whether the provisional instruction created by the instruction unit 21 is in the set of impermissible instructions. Alternatively or additionally, it can be provided that the safety unit 22 checks whether the provisional instruction created by the instruction unit 21 is outside the set of permissible instructions.

In the exemplary embodiment, the instruction unit 21 is arranged in an instruction housing. The safety unit 22 is arranged in a safety housing. Both the instruction housing and the safety housing are arranged in a shared control housing.

The instruction unit 21 is connected to the safety unit 22, in particular electrically connected, by means of a data line 23. The data line 23 is used to exchange digital data between the instruction unit 21 and the safety unit 22. The provisional instruction is conveyed via the data line 23 from the instruction unit 21 to the safety unit 22. In the exemplary embodiment, the data line 23 is a fieldbus, in particular a CAN (controller area network) bus. The data line 23 fulfils the criteria mentioned in the introduction to the description in connection with the CAN bus.

The safety unit 22 only permits forwarding of the provisional instruction to the actuator system 10 in unmodified form if the provisional instruction is outside the set of impermissible instructions. Otherwise, the safety unit 22 prevents forwarding of the provisional instruction to the actuator system 10 or the safety unit 22 modifies the provisional instruction such that it is outside the set of impermissible instructions and then forwards the instruction to the actuator system 10. Alternatively or additionally, it can be provided that the safety unit 22 only permits forwarding of the provisional instruction to the actuator system 10 in unmodified form if the provisional instruction is within the set of permissible instructions. Otherwise, the safety unit 22 prevents forwarding of the provisional instruction to the actuator system 10 or the safety unit 22 modifies the provisional instruction such that it is within the set of permissible instructions and then forwards the instruction to the actuator system 10.

The control unit 20, in particular the instruction unit 21, is designed to be coupled to the at least one operating device 31, 32, 33, 34. By means of the at least one operating device 31, 32, 33, 34, the operator can specify which provisional instruction the instruction unit 21 creates. In the exemplary embodiment, the at least one operating device 31, 32, 33, 34 is used to control operation of the actuator system 10, in particular to control operation of the at least one actuator 11, 12, 13.

In order to couple the at least one operating device 31, 32, 33, 34 to the control unit 20, in particular to the instruction unit 21, the arrangement comprises a first data channel 41. The first data channel 41 is used to transmit data between the at least one operating device 31, 32, 33, 34 and the control unit 20, in particular the instruction unit 21. In the exemplary embodiment, the first data channel 41 is a cable. In the exemplary embodiment, the first data channel 41 is a fieldbus, in particular a CAN (controller area network) bus.

The work apparatus 1 is designed in such a way that the control unit 20, in particular the safety unit 22, transfers a user interface, in particular a menu structure, to the at least one operating device 31, 32, 33, 34 when the at least one operating device 31, 32, 33, 34 is coupled to the control unit 20. In the exemplary embodiment, this is done by transmitting data by means of the first data channel 41. However, it can also be provided that the data transmission is effected by means of a second data channel 42. The second data channel 42 is described in detail further below.

As can be seen from FIG. 1, the arrangement comprises a plurality of operating devices 31, 32, 33, 34. The arrangement comprises a first operating device 31, a second operating device 32, a third operating device 33 and a fourth operating device 34. The plurality of operating devices 31, 32, 33, 34 can be coupled to the control unit 20. By means of the plurality of operating devices 31, 32, 33, 34, an operator can specify which provisional instruction the instruction unit 21 creates. It can be provided that each operating device 31, 32, 33, 34 is assigned to exactly one actuator 11, 12, 13 of the actuator system 10. However, it can also be provided that two different actuators 11, 12, 13 can be controlled by means of one of the plurality of operating devices 31, 32, 33, 34.

In the exemplary embodiment, the provisional instruction created by the instruction unit 21 can be composed of a plurality of sub-instructions. Each operating device 31, 32, 33, 34 is in each case one a sub-instruction. The sub-instruction can be transmitted from the operating device 31, 32, 33, 34 to the instruction unit 21. The instruction unit 21 creates the provisional instruction from the sub-instructions. The safety unit 22 checks whether the provisional instruction created from the sub-instructions is in the set of impermissible instructions. Alternatively or additionally, the safety unit 22 checks whether the provisional instruction created from the sub-instructions is outside the set of permissible instructions. If the provisional instruction is within the set of impermissible instructions or (alternatively or additionally) outside the set of permissible instructions, the safety unit 22 modifies the provisional instruction as if the chronologically last sub-instruction had not been taken into account for the creation of the provisional instruction. Therefore, if a first sub-instruction is initially sent to the instruction unit 21 from the first operating device 31 and then at a later point in time a second sub-instruction is sent from the second operating device 32 to the instruction unit 21 and the instruction unit 21 creates a provisional instruction therefrom which is within the set of impermissible instructions and/or outside the set of permissible instructions, the safety unit 22 modifies the provisional instruction as if it had been created exclusively on the basis of the first sub-instruction of the instruction unit 21. This process is repeated until the modified provisional instruction is outside the set of impermissible instructions and/or within the set of permissible instructions or the modified provisional instruction is attributable exclusively to a single sub-instruction and is still within the set of impermissible instructions and/or outside the set of permissible instructions. Only if a modified provisional instruction is created by the safety unit 22 during this process which is outside the set of impermissible instructions and/or within the set of permissible instructions does the safety unit 22 permit forwarding of the modified instruction to the actuator system 10. It can also be provided that the first and the second sub-instruction originate from the same operating device 31, 32, 33, 34 and are merely generated by the operator at different times.

As shown in FIG. 1, the actuator system 10 comprises a plurality of actuators 11, 12, 13. The control unit 20 issues the instruction for the plurality of actuators 11, 12, 13. A single instruction can therefore be provided for a plurality of different actuators 11, 12, 13.

The control unit 20, in particular the safety unit 22, is designed in such a way that it assigns an instruction that does not meet the ISO 13849 Standard to the set of impermissible instructions. Alternatively or additionally, the control unit 20, in particular the safety unit 22, is designed in such a way that it assigns an instruction that meets the ISO 13849 Standard to the set of permissible instructions.

The second data channel 42 is formed between the control unit 20 and the at least one operating device 31, 32, 33, 34 for the transmission of digital data. Therefore, data can be exchanged between the control unit 20 and the at least one operating device 31, 32, 33, 34 over the first data channel 41, over the second data channel 42 or over the first data channel 41 and the second data channel 42 together. In the exemplary embodiment, the first data channel 41 is a CAN bus. In the exemplary embodiment, data transmission is more secure over the first data channel 41 than over the second data channel 42. The maximum data transmission rate of the second data channel 42 is higher than that of the first data channel 41. Safety-relevant data can be transmitted over the first data channel 41. At the same time, it is possible to transmit data with a large data volume over the second data channel 42. In particular, data that has no effect on the safety of the arrangement, in particular the work apparatus 1, can be transmitted over the second data channel 42. The maximum data transmission rate of the first data channel 41 is 5 Mbit/s, in particular 1 Mbit/s. The maximum data transmission rate of the second data channel 42 is 400 Gbit/s, in particular 200 Gbit/s, in particular 100 Gbit/s, in particular 50 Gbit/s, in particular 40 Gbit/s, in particular 10 Gbit/s, in particular 5 Gbit/s, in particular 2.5 Gbit/s. In the exemplary embodiment, the first data channel 41 is a fieldbus, in particular a CAN bus. In the exemplary embodiment, at least one section of the second data channel 42 is formed by an Ethernet network, in particular by a wireless connection. In the exemplary embodiment, the wireless connection is formed by a Bluetooth connection. However, it can also be provided that the wireless connection is formed by a WLAN (wireless local area network) connection. The WLAN connection meets the criteria of the IEEE 802.11 family of standards. In an alternative configuration, it can be provided that at least one section of the second data channel is formed by an Ethernet cable. However, it can also be provided that a section of the second data channel is formed by an Ethernet cable and that a further section of the second data channel is formed by one of the described wireless connections. The Ethernet network is configured in accordance with the IEEE 802.3 Standard.

In the exemplary embodiment, the arrangement is designed in such a way that data can be transmitted over the second data channel 42 by means of the black channel principle. At least a section of the second data channel 42 forms a black channel. The second data channel 42 comprises a first transceiver point on sides of the at least one operating device 31, 32, 33, 34. The second data channel 42 comprises a second transceiver point on sides of the control unit 20. Both the first and the second transceiver point are formed by a fieldbus, in particular a CAN bus.

It can be provided that the at least one operating device 31, 32, 33, 34 is supplied with power via the second data channel 42, in particular via the Ethernet cable. It can also be provided that no first data channel 41 is provided. Data is then exchanged between the at least one operating device 31, 32, 33, 34 exclusively via the second data channel 42.

In the exemplary embodiment, each operating device 31, 32, 33, 34 is assigned a first data channel 41 and a second data channel 42.

What is claimed is:

1. A work apparatus, comprising:
an actuator system (10) including at least one actuator (11, 12, 13); and
a control unit (20) for controlling the actuator system (10), the control unit (20) comprising an instruction unit (21) and a safety unit (22),
wherein the control unit (20) issues an instruction for the actuator system (10) to control the actuator system (10),
wherein the safety unit (22) is functionally arranged between the instruction unit (21) and the actuator system (10),
wherein the instruction unit (21) creates a provisional instruction for the actuator system (10),
wherein a set of impermissible instructions and/or a set of permissible instructions is defined in the safety unit (22),
wherein the safety unit (22) is configured to determine
whether the provisional instruction belongs to the set of impermissible instructions, and permits forwarding the provisional instruction to the actuator system (10) in unmodified form only if the provisional instruction is not included in the set of impermissible instructions
and/or
whether the provisional instruction belongs to the set of permissible instructions and permits forwarding the provisional instruction to the actuator system (10) in unmodified form only if the provisional instruction is included in the set of permissible instructions.

2. The work apparatus according to claim 1,
wherein the control unit (20) is coupled to at least one operating device (31, 32, 33, 34), and
wherein an operator can specify by the at least one operating device (31, 32, 33, 34) which provisional instruction the instruction unit (21) creates.

3. The work apparatus according to claim 2,
wherein the instruction unit (21) is coupled to at least one operating device (31, 32, 33, 34), and
wherein an operator can specify by the at least one operating device (31, 32, 33, 34) which provisional instruction the instruction unit (21) creates.

4. The work apparatus according to claim 3,
wherein the safety unit (22) transfers a menu structure to the at least one operating device (31, 32, 33, 34) when the at least one operating device (31, 32, 33, 34) is coupled to the control unit (20).

5. The work apparatus according to claim 2,
wherein the control unit (20) transfers a user interface to the at least one operating device (31, 32, 33, 34) when the at least one operating device (31, 32, 33, 34) is coupled to the control unit (20).

6. The work apparatus according to claim 1,
wherein a plurality of operating devices (31, 32, 33, 34) can be coupled to the control unit (20), and
wherein an operator can specify by the plurality of operating devices (31, 32, 33, 34) which provisional instruction the instruction unit (21) creates.

7. The work apparatus according to claim 6,
wherein each respective operating device (31, 32, 33, 34) of the plurality of operating devices (31, 32, 33, 34) is assigned a sub-instruction that can be transmitted from the respective operating device (31, 32, 33, 34) to the instruction unit (21),
wherein the instruction unit (21) creates the provisional instruction from the sub-instructions,
wherein, in case that the provisional instruction is within the set of impermissible instructions or outside the set of permissible instructions, the safety unit (22) modifies the provisional instruction to create a modified provisional instruction by disregarding a chronological last sub-instruction of the sub-instructions, and
wherein this process is repeated until the modified provisional instruction is outside the set of impermissible instructions or within the set of permissible instructions and the safety unit (22) permits forwarding of the modified provisional instruction to the actuator system (10).

8. The work apparatus according to claim 1,
wherein the actuator system (10) comprises a plurality of actuators (11, 12, 13), and
wherein the control unit (20) issues the instruction for the plurality of actuators (11, 12, 13).

9. The work apparatus according to claim 1,
wherein the safety unit (22) is configured
to assign an instruction that does not meet the ISO 13849 Standard to the set of impermissible instructions and/or
to assign an instruction that meets the ISO 13849 Standard to the set of permissible instructions.

10. The work apparatus according to claim 1,
wherein the actuator system (10) comprises a winch, a motor for pivoting a jib arm of a crane, a hydraulic cylinder, and/or a motor for driving a wheel for locomotion.

11. An arrangement, comprising:
at least one operating device (31, 32, 33, 34); and
the work apparatus (1) according to claim 1,
wherein a first data channel (41) for transmitting digital data is formed between the control unit (20) and the at least one operating device (31, 32, 33, 34), and
wherein the first data channel (41) is a fieldbus.

12. The arrangement according to claim 11,
wherein a second data channel (42) for transmitting digital data is formed between the control unit (20) and the at least one operating device (31, 32, 33, 34), and
wherein the arrangement is configured to transmit data over the second data channel (42) according to the black channel principle.

13. The arrangement according to claim 12,
wherein the second data channel (42) comprises a first transceiver point on sides of the at least one operating device (31, 32, 33, 34),
wherein the second data channel (42) comprises a second transceiver point on sides of the control unit (20), and
wherein both the first and the second transceiver point is formed by a fieldbus.

14. The arrangement according to claim 12,
wherein at least one section of the second data channel (42) is formed by an Ethernet cable.

15. The arrangement according to claim 12,
wherein the at least one operating device (31, 32, 33, 34) is supplied with power via the second data channel (42).

16. The arrangement according to claim 12,
wherein at least one section of the second data channel (42) is a wireless connection.

17. The arrangement according to claim 11,
wherein the work apparatus (1) is a crane.
